(19) United States
(12) Patent Application Publication
(10) Pub. No.: US 2011/0142453 A1
(43) Pub. Date: Jun. 16, 2011

(54) OPTICAL TRANSCEIVER AND METHOD FOR CONTROLLING THE SAME

(75) Inventors: Jyung Chan Lee, (US); Joon Ki Lee, (US); Sae-Kyoung Kang, (US); Kwangjoon Kim, (US)

(73) Assignee: Electronics and Telecommunications Research Institute, Daejeon (KR)

(21) Appl. No.: 12/951,446

(22) Filed: Nov. 22, 2010

(30) Foreign Application Priority Data
Dec. 11, 2009 (KR) 10-2009-0123297
Apr. 29, 2010 (KR) 10-2010-0040150

(51) Int. Cl. H04B 10/00

(52) U.S. Cl. 398/135

(57) ABSTRACT

An optical transceiver includes: a transmission unit configured to convert a first electrical signal into a first optical signal and transmit the converted first optical signal; a first power supply unit configured to supply power to the transmission unit; and a controller configured to control the first power supply unit, wherein the controller controls an operation of the first power supply unit according to whether or not the first electrical signal is inputted to the transmission unit.

### CROSS-REFERENCE TO RELATED APPLICATION

This application claims priority to and the benefit of Korean Patent Application Nos. 10-2009-0123297 and 10-2010-0040150 filed in the Korean Intellectual Property Office on Dec. 11, 2009 and Apr. 29, 2010, the entire contents of which are incorporated herein by reference.

### BACKGROUND OF THE INVENTION

(a) Field of the Invention

The present invention relates to an optical transceiver and a method for controlling the same.

(b) Description of the Related Art

An optical transceiver serves to convert a light signal into an electrical signal or an electrical signal to an optical signal for optical communication. To this end, the optical transceiver includes a light reception element, a light transmission element, an amplifying element, a multiplexing element, a demultiplexing element, a high speed signal reproducing element, and the like. Recently, the optical transceiver has evolved from 2.5 Gbps to 10 Gbps to 40 Gbps, and the like, to have a higher speed. As the operational speed of the optical transceiver increases, power consumption of the elements of the optical transceiver increases, so the optical transceiver is required to be effectively controlled.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an optical transceiver having advantages of effectively reducing power consumption when the optical transceiver does not operate and effectively changing the optical transceiver to an operational state when the optical transceiver needs to operate, by appropriately controlling power of the optical transceiver.

An exemplary embodiment of the present invention provides an optical transceiver including: a transmission unit configured to convert a first electrical signal into a first optical signal and transmit the converted first optical signal; a first power supply unit configured to supply power to the transmission unit; and a controller configured to control the first power supply unit, wherein the controller controls an operation of the first power supply unit according to whether or not the first electrical signal is inputted to the transmission unit.

The controller may further control the operation of the first power supply unit based on whether or not the first electrical signal inputted to the transmission unit is data-locked.

The transmission unit may include an electrical signal processing unit configured to process the first electrical signal such that the first electrical signal fits the operation of the transmission unit, an amplifier configured to amplify an output signal from the electrical signal processing unit, and an electro-optical converter configured to convert an output signal from the amplifier into the first optical signal.

The controller may control the operation of the first power supply unit according to whether or not the first electrical signal is inputted to the electrical signal processing unit.

When the first electrical signal is not inputted, the controller may control the first power supply unit to not operate.

When the first electrical signal is inputted to the electrical signal processing unit, the controller may further control the operation of the first power supply unit based on whether or not the first electrical signal is data-locked.

When the first electrical signal is not data-locked, the controller may control the first power supply unit to not operate, and when the first electrical signal is data-locked, the controller may control the first power supply unit to operate.

The optical transceiver may further include a signal line connected between the electrical signal processing unit and the controller, wherein whether or not the first electrical signal is inputted to the electrical signal processing unit may be determined through the signal line.

The optical transceiver may further include a reception unit configured to receive a second optical signal from an external source and convert the received second optical signal into a second electrical signal, and a second power supply unit configured to supply power to the reception unit and that is controlled by the controller.

The controller may control an operation of the second power supply unit based on whether or not the second optical signal is inputted to the reception unit.

The reception unit may include a photo-electric converter configured to receive the second optical signal and convert the received second optical signal into the second electrical signal, an amplifier configured to amplify an output signal from the photo-electric converter, and an electrical signal processing unit configured to process an output signal from the amplifier.

The controller may control the operation of the second power supply unit according to whether or not the second optical signal is inputted to the photo-electric converter.

When the second optical signal is not inputted, the controller may control the second power supply unit to not operate, and when the second optical signal is inputted, the controller may control the second power supply unit to operate.

The optical transceiver may further include a signal line connected between the photo-electric converter and the controller, wherein whether or not the second optical signal is inputted to the photo-electric converter may be determined through the signal line.

Another embodiment of the present invention provides an optical transceiver including a photo-electric converter configured to receive an optical signal from an external source and convert the received optical signal into an electrical signal, a power supply unit configured to supply power to the photo-electric converter, and a controller configured to control the power supply unit, wherein the controller controls an operation of the power supply unit according to whether or not the optical signal is inputted to the photo-electric converter.

When the optical signal is not inputted, the controller may control the power supply unit to not operate, and when the optical signal is inputted, the controller may control the power supply unit to operate.

Yet another embodiment of the present invention provides a method for controlling power of an optical transceiver including a transmission unit, a first power supply unit supplying power to the transmission unit, and a controller controlling the first power supply unit, the method including determining whether or not an electrical signal is inputted to the transmission unit of the optical transceiver, and controlling, by the controller, an operation of the power supply unit according to the determination result.

The controlling of the power supply unit may include: when the electrical signal is not inputted, controlling, by the controller, the first power supply unit to not operate; when the electrical signal is inputted, determining whether or not the electrical signal is in a data-locked state; when the electrical signal is not in the data-locked state, controlling, by the controller, the first power supply unit to not operate; and when the electrical signal is in the data-locked state, controlling, by the controller, the first power supply unit to operate.

The optical transceiver may further include: a reception unit and a second power supply unit supplying power to the reception unit, and the method may further include: determining whether or not an optical signal is inputted to the reception unit; when the optical signal is not inputted, controlling, by the controller, the second power supply unit to not operate; and when the optical signal is inputted, controlling, by the controller, the second power supply unit to operate.

Still another embodiment of the present invention provides a method for controlling power of an optical transceiver including a reception unit, a power supply unit supplying power to the reception unit, and a controller controlling the power supply unit, the method including: determining whether or not an optical signal is inputted to the reception signal; when the optical signal is not inputted, controlling, by the controller, the power supply unit to not operate; and when the optical signal is inputted, controlling, by the controller, the power supply unit to operate.

According to exemplary embodiments of the present invention, power consumption when the optical transceiver does not operate can be effectively reduced, and when the optical transceiver is to operate, power can be controlled such that the optical transceiver is effectively changed to an optical state.

### BRIEF DESCRIPTION OF THE DRAWINGS

FIG. 1 is a schematic block diagram of an optical transceiver according to an exemplary embodiment of the present invention.

FIG. 2 is a flowchart illustrating the process of a method for controlling a transmission unit of the optical transceiver according to an exemplary embodiment of the present invention.

FIG. 3 is a flowchart illustrating the process of a method for controlling a reception unit of the optical transceiver according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

An optical transceiver and a method for controlling an optical transceiver according to an exemplary embodiment of the present invention will now be described in detail with reference to the accompanying drawings.

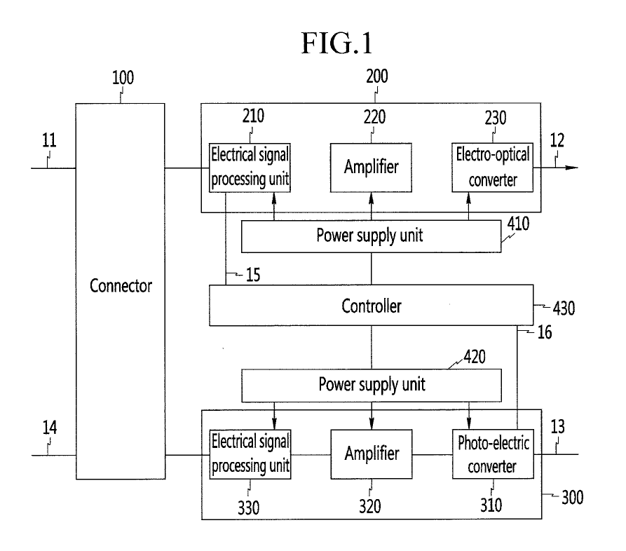

FIG. 1 is a schematic block diagram of an optical transceiver according to an exemplary embodiment of the present invention.

With reference to FIG. 1, the optical transceiver includes a connector 100, a transmission unit 200, a reception unit 300, power supply units 410 and 420, and a controller 430.

The connector 100, an optical connection medium, receives an electrical signal inputted through an input electrical signal line 11 and transfers it to the transmission unit 200, and transfers an electrical signal from the reception unit 300 through an output electrical signal line 14.

The transmission unit 200 converts the electrical signal transferred from the connector 100 into an optical signal and transmits the converted optical signal through an output optical signal line 12. The transmission unit 200 includes an electrical signal processing unit 210, an amplifier 220, and an electro-optical converter 230.

The electrical signal processing unit 210 processes the electrical signal transferred from the connector 100 such that it fits the operation of the transmission unit 200.

The amplifier 220 amplifies the electrical signal processed by the electrical signal processing unit 210 and transfers the amplified electrical signal to the electro-optical converter 230.

The electro-optical converter 230 converts the amplified electrical signal into an optical signal and transmits the converted optical signal through the output optical signal line.

The reception unit 300 receives an optical signal from an input optical signal line 13, converts the received optical signal into an electrical signal, and transfers the converted electrical signal through the output electrical signal line 14. The reception unit 300 includes a photo-electric converter 310, an amplifier 320, and an electrical signal processing unit 330.

The photo-electric converter 310 converts the optical signal from the input optical signal line 13 into an electrical signal and transfers the converted electrical signal to the amplifier 320.

The amplifier 320 amplifies the converted electrical signal and transfers the amplified electrical signal to the electrical signal processing unit 330.

The electrical signal processing unit 330 processes the electrical signal transferred from the amplifier 320 such that it fits a modular operation after the connector 100.

The power supply unit 410 supplies power to the electrical signal processing unit 210, the amplifier 220, and the electro-optical converter 230.

The power supply unit 420 supplies power to the photo-electric converter 310, the amplifier 320, and the electrical signal processing unit 330.

The controller 430 controls operations of the power supply units 410 and 420.

A signal line 15 is used to determine whether or not the power supply unit 410 connected with the elements 210, 220, and 230 of the transmission unit 200 operates. In detail, whether or not the power supply unit 410 operates is determined based on whether or not an electrical signal is inputted to the electrical signal processing unit 210 through the input electrical signal line 11 and the connector 100 and whether or not the electrical signal is data-locked.

A signal line 16 is used to determine whether or not the power supply unit 420 connected with the elements 310, 320, and 330 of the reception unit 300 operates. In detail, whether or not the power supply unit 420 operates is determined based on whether or not an optical signal is inputted to the photo-electric converter 310 through the input optical signal line 13.

The controller 430 operates the power supply units 410 and 420 or does not operate them according to the determination results through the signal lines 15 and 16.

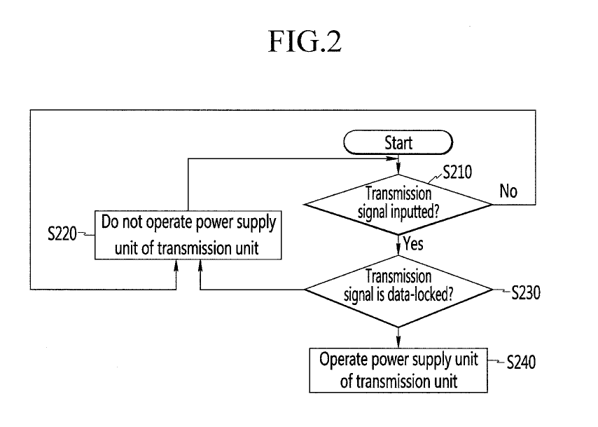

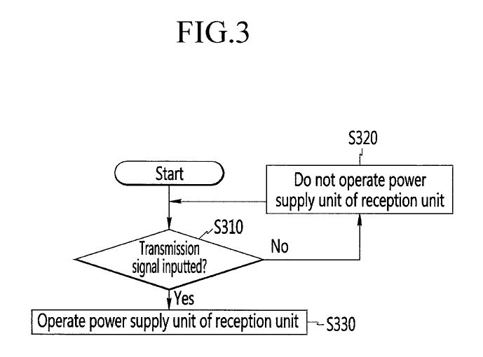

A method for controlling an optical transceiver according to an exemplary embodiment of the present invention will now be described in detail with reference to FIGS. 2 and 3.

FIG. 2 is a flowchart illustrating the process of a method for controlling a transmission unit of the optical transceiver according to an exemplary embodiment of the present invention.

With reference to FIG. 2, whether or not a transmission signal, namely, an electrical signal, is inputted to the electrical signal processing unit 210 is determined through the signal line 15 that connects the electrical signal processing unit of the transmission unit 200 of the optical transceiver and the controller 430 (S210).

When a transmission signal is not inputted according to the determination result, the controller 430 controls the power supply unit 410 to not operate (S220).

When a transmission signal is inputted according to the determination result, it is determined whether or not the transmission signal is data-locked (S230).

When the transmission signal is not data-locked according to the determination result, the controller 430 controls the power supply unit 410 of the transmission unit 200 to not operate (S220). When the transmission signal is data-locked according to the determination result, the controller 430 controls the power supply unit 410 of the transmission unit 200 to operate (S240).

FIG. 3 is a flowchart illustrating the process of a method for controlling a reception unit of the optical transceiver according to an exemplary embodiment of the present invention.

With reference to FIG. 3, whether or not a reception signal, namely, an optical signal, is inputted to the photo-electric converter 310 is determined through the signal line 16 that connects the photo-electric converter 310 of the reception unit 300 of the optical transceiver and the controller 430 (S310).

When an optical signal does is not inputted according to the determination result, the controller 430 controls the power supply unit 420 not to operate (S320).

When an optical signal is inputted according to the determination result, the controller 430 controls the power supply unit 420 to operate (S330).

In this manner, power is controlled based on the presence of the signals inputted to the transmission unit 200 and the reception unit 300, whereby power of the optical transceiver can be effectively controlled without using any additional device or additional signal, and thus, power consumption of the optical transceiver can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An optical transceiver comprising:
a transmission unit converting a first electrical signal into a first optical signal and transmit the converted first optical signal;
a first power supply unit supplying power to the transmission unit; and
a controller controlling the first power supply unit,
wherein the controller controls an operation of the first power supply unit according to whether or not the first electrical signal is inputted to the transmission unit.

2. The optical transceiver of claim 1, wherein the controller further controls the operation of the first power supply unit based on whether or not the first electrical signal inputted to the transmission unit is data-locked.

3. The optical transceiver of claim 1, wherein the transmission unit comprises:
an electrical signal processing unit processing the first electrical signal such that the first electrical signal fits the operation of the transmission unit;
an amplifier amplifying an output signal from the electrical signal processing unit; and
an electro-optical converter converting an output signal from the amplifier into the first optical signal.

4. The optical transceiver of claim 3, wherein the controller controls the operation of the first power supply unit according to whether or not the first electrical signal is inputted to the electrical signal processing unit.

5. The optical transceiver of claim 4, wherein when the first electrical signal is not inputted, the controller controls the first power supply unit to not operate.

6. The optical transceiver of claim 4, wherein when the first electrical signal is inputted to the electrical signal processing unit, the controller further controls the operation of the first power supply unit based on whether or not the first electrical signal is data-locked.

7. The optical transceiver of claim 6, wherein when the first electrical signal is not data-locked, the controller controls the first power supply unit to not operate, and when the first electrical signal is data-locked, the controller controls the first power supply unit to operate.

8. The optical transceiver of claim 4, further comprising
a signal line connected between the electrical signal processing unit and the controller,
wherein whether or not the first electrical signal is inputted to the electrical signal processing unit is determined through the signal line.

9. The optical transceiver of claim 1, further comprising:
a reception unit receiving a second optical signal from an external source and convert the received second optical signal into a second electrical signal; and
a second power supply unit supplying power to the reception unit and that is controlled by the controller.

10. The optical transceiver of claim 9, wherein the controller controls an operation of the second power supply unit based on whether or not the second optical signal is inputted to the reception unit.

11. The optical transceiver of claim 9, wherein the reception unit comprises:
a photo-electric converter receiving the second optical signal and convert the received second optical signal into the second electrical signal;
an amplifier amplifying an output signal from the photo-electric converter; and
an electrical signal processing unit processing an output signal from the amplifier.

12. The optical transceiver of claim 11, wherein the controller controls the operation of the second power supply unit according to whether or not the second optical signal is inputted to the photo-electric converter.

13. The optical transceiver of claim 12, wherein when the second optical signal is not inputted, the controller controls the second power supply unit to not operate, and when the second optical signal is inputted, the controller controls the second power supply unit to operate.

14. The optical transceiver of claim 12, further comprising
a signal line connected between the photo-electric converter and the controller,
wherein whether or not the second optical signal is inputted to the photo-electric converter is determined through the signal line.

15. An optical transceiver comprising:
a photo-electric converter receiving an optical signal from an external source and convert the received optical signal into an electrical signal;
a power supply unit supplying power to the photo-electric converter; and
a controller controlling the power supply unit,
wherein the controller controls an operation of the power supply unit according to whether or not the optical signal is inputted to the photo-electric converter.

16. The optical transceiver of claim 15, further comprising:
an amplifier amplifying an output signal from the photo-electric converter; and
an electrical signal processing unit processing an output signal from the amplifier,
wherein the power supply unit supplies power to the amplifier and the electrical signal processing unit, and
when the optical is not inputted, the controller controls the power supply unit to not operate, and when the optical signal is inputted, the controller controls the power supply unit to operate.

17. A method for controlling power of an optical transceiver comprising a transmission unit, a first power supply unit supplying power to the transmission unit, and a controller controlling the first power supply unit, the method comprising:
determining whether or not an electrical signal is inputted to the transmission unit of the optical transceiver; and
controlling, by the controller, an operation of the power supply unit according to the determination result.

18. The method of claim 17, wherein the controlling of the power supply unit comprises:
when the electrical signal is not inputted, controlling, by the controller, the first power supply unit to not operate;
when the electrical signal is inputted, determining whether or not the electrical signal is in a data-locked state;
when the electrical signal is not in the data-locked state, controlling, by the controller, the first power supply unit to not operate; and
when the electrical signal is in the data-locked state, controlling, by the controller, the first power supply unit to operate.

19. The method of claim 17, wherein the optical transceiver further comprises a reception unit and a second power supply unit supplying power to the reception unit,
wherein the method further comprises:
determining whether or not an optical signal is inputted to the reception unit;
when the optical signal is not inputted, controlling, by the controller, the second power supply unit to not operate; and
when the optical signal is inputted, controlling, by the controller, the second power supply unit to operate.

20. The method for controlling power of an optical transceiver comprising a reception unit, a power supply unit supplying power to the reception unit, and a controller controlling the power supply unit, the method comprising:
determining whether or not an optical signal is inputted to the reception signal;
when the optical signal is not inputted, controlling, by the controller, the power supply unit to not operate; and
when the optical signal is inputted, controlling, by the controller, the power supply unit to operate.
